(19) United States
(12) Patent Application Publication
(10) Pub. No.: US 2026/0251804 A1
(43) Pub. Date: Aug. 27, 2026

(54) INFORMATION PROCESSING METHOD, INFORMATION PROCESSING DEVICE, INFORMATION PROCESSING SYSTEM, AND STORAGE MEDIUM

(71) Applicant: HONDA MOTOR CO., LTD., Tokyo (JP)

(72) Inventor: Takahiro KUROKI, Saitama (JP)

(73) Assignee: HONDA MOTOR CO., LTD., Tokyo (JP)

(21) Appl. No.: 19/530,384

(22) Filed: Feb. 5, 2026

(30) Foreign Application Priority Data
Feb. 25, 2025 (JP) 2025-027935

(51) Int. Cl. G01S 19/39; G01S 17/89; G05D 1/248; G05D 105/20; G05D 109/10; G05D 111/10; G05D 111/30

(52) U.S. Cl. CPC G01S 19/396; G01S 17/89; G05D 1/248; G05D 2105/20; G05D 2109/10; G05D 2111/17; G05D 2111/30

(57) ABSTRACT

An information processing method for estimating a reception state of a signal from a positioning satellite in a moving object provided with a receiver that receives the signal includes acquiring, by a processor, three-dimensional point cloud information on a periphery of the moving object, extracting, by the processor, a target point included in a predetermined solid from the three-dimensional point cloud information, the predetermined solid representing a receivable range of the receiver, generating, by the processor, a two-dimensional image obtained by projecting the target point included in the solid onto a two-dimensional plane from a direction corresponding to a vertical direction of the moving object, and estimating, by the processor, the reception state based on the target point in the two-dimensional image.

This application is based on and claims priority under 35 USC 119 from Japanese Patent Application No. 2025-027935 filed on Feb. 25, 2025, the entire contents of which are incorporated herein by reference.

### TECHNICAL FIELD

The present disclosure relates to an information processing method, an information processing device, an information processing system, and a non-transitory computer-readable storage medium.

### BACKGROUND ART

In the related art, a technique of positioning a current position of a moving object based on a signal received from a positioning satellite, such as a global navigation satellite system (GNSS), is well-known.

JP2007-003287A discloses a technique of estimating in advance a sky openness ratio, which is a ratio of sky to a GPS reception area set in advance in sky above a host vehicle, and predicting, based on the estimated sky openness ratio, whether a GPS loss occurs, in which positioning based on radio waves from a GPS satellite becomes impossible.

### SUMMARY OF INVENTION

The positioning accuracy of positioning based on a signal received from a positioning satellite varies depending on a reception state of the signal. For example, the signal intensity, the multi-path interference (multi-path), the satellite arrangement, an influence of ionosphere and troposphere, and the like may affect the positioning accuracy. Therefore, there is a demand for grasping the reception state of the signal from the positioning satellite. However, in the related art, there is room for improvement in accurately estimating a reception state of a signal from a positioning satellite while reducing a calculation load for estimating the reception state.

Aspects of non-limiting embodiments of the present disclosure relate to an information processing method, an information processing device, an information processing system, and a non-transitory computer-readable storage medium storing the program capable of accurately estimating a reception state of a signal from a positioning satellite while reducing a calculation load for estimating the reception state.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided An information processing method for estimating a reception state of a signal from a positioning satellite in a moving object provided with a receiver that receives the signal, including acquiring, by a processor, three-dimensional point cloud information on a periphery of the moving object, extracting, by the processor, a target point included in a predetermined solid from the three-dimensional point cloud information, the predetermined solid representing a receivable range of the receiver, generating, by the processor, a two-dimensional image obtained by projecting the target point included in the solid onto a two-dimensional plane from a direction corresponding to a vertical direction of the moving object, and estimating, by the processor, the reception state based on the target point in the two-dimensional image.

According to another aspect of the present disclosure, there is provided An information processing device that estimates a reception state of a signal from a positioning satellite in a moving object provided with a receiver that receives the signal, the information processing device including a processor configured to acquire three-dimensional point cloud information on a periphery of the moving object, extract a target point included in a predetermined solid from the three-dimensional point cloud information, the predetermined solid representing a receivable range of the receiver, generate a two-dimensional image obtained by projecting the target point included in the solid onto a two-dimensional plane from a direction corresponding to a vertical direction of the moving object, and estimate the reception state based on the target point in the two-dimensional image.

According to another aspect of the present disclosure, there is provided A non-transitory computer-readable storage medium storing a program for causing a computer to execute a process for estimating a reception state of a signal from a positioning satellite in a moving object provided with a receiver that receives the signal, the process including acquiring three-dimensional point cloud information on a periphery of the moving object, extracting a target point included in a predetermined solid from the three-dimensional point cloud information, the predetermined solid representing a receivable range of the receiver, generating a two-dimensional image obtained by projecting the target point included in the solid onto a two-dimensional plane from a direction corresponding to a vertical direction of the moving object, and estimating the reception state based on the target point in the two-dimensional image.

According to an aspect of the present disclosure, it is possible to provide an information processing method, an information processing device, an information processing system, and a non-transitory computer-readable storage medium capable of accurately estimating a reception state of a signal from a positioning satellite while reducing a calculation load for estimating the reception state.

### BRIEF DESCRIPTION OF DRAWINGS

Exemplary embodiment(s) of the present invention will be described in detail based on the following figures, wherein:

FIG. 1 is a side view showing an example of an autonomous work machine 10 constituting an information processing system 1 of the present embodiment;

FIG. 2 is a front view showing the example of the autonomous work machine 10;

FIG. 3 is a diagram showing an example of a virtual inverted cone CV representing a receivable range RV of a GNSS antenna 13 including a right antenna 13R and a left antenna 13L;

FIG. 4 is a block diagram showing an example of a hardware configuration of the autonomous work machine 10;

FIG. 5 shows an example of target points CP which are object detection points included in the virtual inverted cone CV representing the receivable range RV of the GNSS antenna 13;

FIG. 6A and FIG. 6B show examples of a two-dimensional image G obtained by projecting the virtual inverted cone CV and the target points CP on a two-dimensional plane, and a sky openness area So;

FIG. 7A and FIG. 7B are diagrams showing an example of deriving the sky openness area So;

FIG. 8 is a flowchart (part 1) showing an example of a processing procedure performed by a processor 101;

FIG. 9 is a flowchart (part 2) showing the example of the processing procedure performed by the processor 101; and

FIG. 10 is a block diagram showing a modification of the information processing system 1 of the present embodiment.

### DESCRIPTION OF EMBODIMENTS

Hereinafter, exemplary embodiments of an information processing method, an information processing device, an information processing system, and a non-transitory computer-readable storage medium according to the present disclosure will be described with reference to the drawings.

The drawings are viewed in directions of the reference numerals, and in the drawings, a front side is denoted by Fr, a rear side is denoted by Rr, a left side is denoted by L, a right side is denoted by R, an upper side is denoted by U, and a lower side is denoted by D. Not all the elements to be described in the following embodiments are necessarily essential for the present invention. Hereinafter, the same or similar elements are denoted by the same or similar reference numerals, and the description thereof may be omitted or simplified as appropriate.

### Schematic Configuration of Autonomous Work Machine

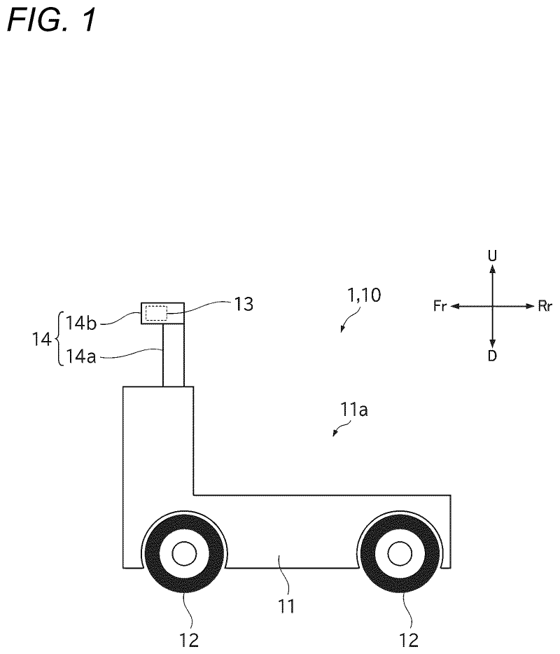

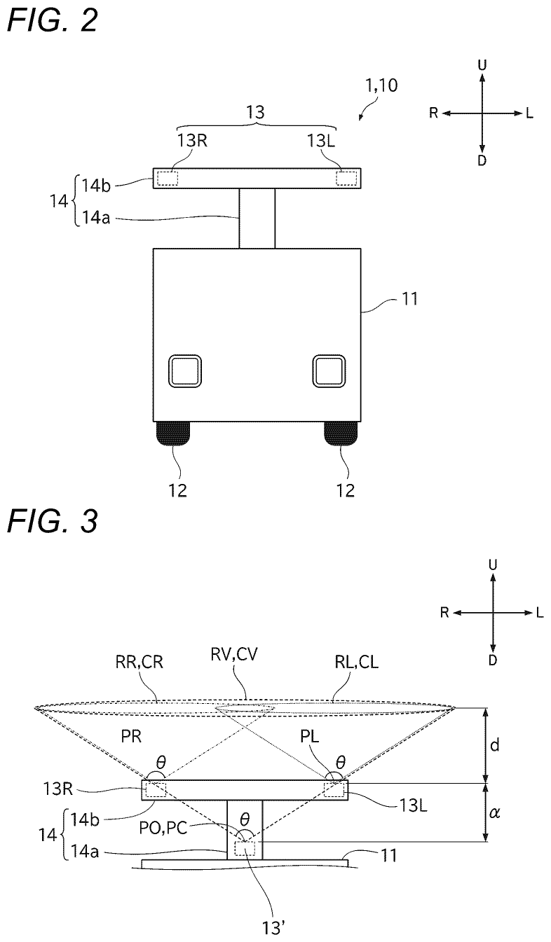

First, an example of a schematic configuration of an autonomous work machine 10 constituting an information processing system 1 of the present embodiment will be described with reference to FIGS. 1 and 2.

The autonomous work machine 10 shown in FIGS. 1 and 2 is, for example, a moving object that autonomously moves to carry a package, a material, or the like in a predetermined work place such as a construction site, a farm, or a harbor. Here, the autonomous movement is movement that does not depend on a human operation. The autonomous movement may include movement under a control from an external device (for example, a server) capable of communicating with the autonomous work machine 10.

As shown in FIGS. 1 and 2, the autonomous work machine 10 includes a vehicle body 11 having a loading platform 11a on which package or the like can be loaded, wheels 12 that support the vehicle body 11, and a GNSS antenna 13 that functions as a receiver that receives a signal (hereinafter, also referred to as a “GNSS signal”) from a positioning satellite of a global navigation satellite system (GNSS).

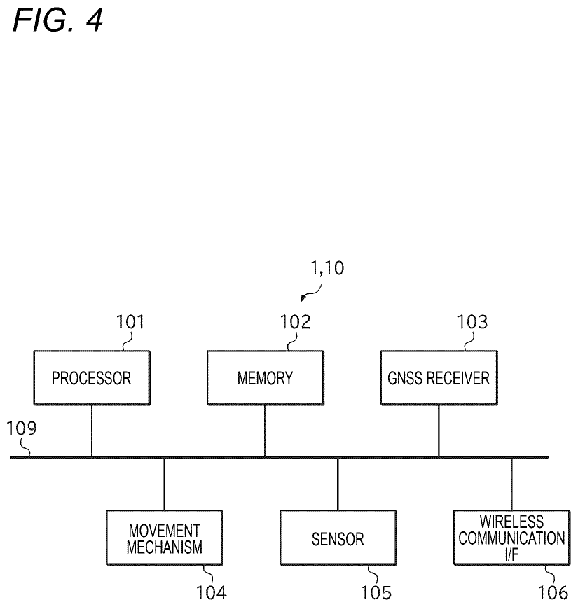

The wheels 12 are included in a movement mechanism 104 (see FIG. 4) that implements autonomous movement of the autonomous work machine 10. As the wheels 12, for example, a pair of left and right front wheels provided at a lower portion on a front side of the vehicle body 11 and a pair of left and right rear wheels provided at a lower portion on a rear side of the vehicle body 11 are provided. Some or all of the wheels 12 function as drive wheels driven by a drive source (for example, a motor to be described later). Some or all of these wheels 12 also function as steered wheels that implement a direction change of the autonomous work machine 10. The wheels 12 are not limited to four wheels, and may be, for example, three wheels or six wheels.

The vehicle body 11 is provided with an antenna holding unit 14 that holds the GNSS antenna 13. The antenna holding unit 14 includes a pillar portion 14a and an arm portion 14b. The pillar portion 14a protrudes upward from a center in a width direction (left-right direction) of a front end of the vehicle body 11. The arm portion 14b extends symmetrically in the width direction of the vehicle body 11 from an upper end of the pillar portion 14a.

The GNSS antenna 13 includes, for example, a right antenna 13R and a left antenna 13L each capable of independently receiving an GNSS signal. The right antenna 13R is provided at the right end of the arm portion 14b of the antenna holding unit 14. On the other hand, the left antenna 13L is provided at the left end of the arm portion 14b of the antenna holding unit 14. The right antenna 13R and the left antenna 13L are disposed symmetrically on the right and left with respect to the center in the width direction (that is, the left-right direction) of the vehicle body 11.

As described above, by providing the right antenna 13R and the left antenna 13L as the GNSS antenna 13, a positional relationship between the right antenna 13R and the positioning satellite can be derived based on the GNSS signal received by the right antenna 13R, and a positional relationship between the left antenna 13L and the positioning satellite can be derived based on the GNSS signal received by the left antenna 13L. Based on the positional relationship between the right antenna 13R and the positioning satellite and the positional relationship between the left antenna 13L and the positioning satellite, it is possible to obtain not only a current position of the autonomous work machine 10 but also information on a posture of the autonomous work machine 10, for example, how much the vehicle body 11 is inclined with respect to the ground.

### Reception Range of GNSS Antenna

Next, an example of a receivable range of the GNSS antenna 13 will be described with reference to FIG. 3. As shown in FIG. 3, a receivable range RR, which is a hardware characteristic indicating the range in which the right antenna 13R can receive the GNSS signal, can be generally represented by an inverted cone CR having a vertex angle of a predetermined angle θ with the center of the right antenna 13R (for example, an upper surface of the right antenna 13R) as a vertex PR and a height of a predetermined distance d. The predetermined angle θ and the predetermined distance d in this case are determined from, for example, hardware characteristics of the right antenna 13R. The “inverted cone” in the present specification means a cone whose bottom surface faces directly above the autonomous work machine 10.

Similarly, a receivable range RL in which the left antenna 13L can receive the GNSS signal, depending on hardware, can be generally represented by an inverted cone CL having a vertex angle of a predetermined angle θ with the center of the left antenna 13L (for example, an upper surface of the left antenna 13L) as a vertex PL and a height of the predetermined distance d. The predetermined angle θ and the predetermined distance d in this case are determined from, for example, hardware characteristics of the left antenna 13L.

In the present embodiment, from a viewpoint of reducing a calculation load, a virtual inverted cone CV which is an inverted cone (that is, a solid) including the receivable range RR of the right antenna 13R and the receivable range RL of the left antenna 13L is treated as a receivable range RV of the GNSS antenna 13 including the right antenna 13R and the left antenna 13L. In such a case, it can be considered that a single virtual GNSS antenna 13′ having the virtual inverted cone CV as the receivable range RV is provided in the autonomous work machine 10.

The virtual inverted cone CV has a reference point PO determined by attachment positions of the right antenna 13R and the left antenna 13L as a vertex PC. As an example, the vertex PC is located immediately below a center of a line segment connecting the center of the right antenna 13R (in other words, the vertex PR) and the center of the left antenna 13L (in other words, the vertex PL). The virtual inverted cone CV has a vertex angle of a predetermined angle θ, and a height of d+α. Here, α represents a distance in an upper-lower direction between the vertex PC of the virtual inverted cone CV and the line segment connecting the vertex PR of the inverted cone CR and the vertex PL of the inverted cone CL, and is larger than 0 (zero).

In the present embodiment, an example in which the virtual inverted cone CV is used as the receivable range RV of the GNSS antenna 13 is described, but the present invention is not limited thereto. For example, a truncated cone or a hemisphere including the receivable range RR of the right antenna 13R and the receivable range RL of the left antenna 13L and having a bottom surface facing directly above the autonomous work machine 10 may be used as the receivable range RV instead of the virtual inverted cone CV. As an example, the truncated cone in this case can be a truncated cone obtained by cutting a plane of the virtual inverted cone CV, the plane passing through the vertex PR of the receivable range RR of the right antenna 13R and the vertex PL of the receivable range RL of the left antenna 13L.

### Hardware Configuration of Autonomous Work Machine

Next, an example of a hardware configuration of the autonomous work machine 10 constituting the information processing system 1 of the present embodiment will be described with reference to FIG. 4. As shown in FIG. 4, the autonomous work machine 10 includes a processor 101, a memory 102, a GNSS receiver 103, the movement mechanism 104, a sensor 105, and a wireless communication I/F (interface) 106. The processor 101, the memory 102, the GNSS receiver 103, the movement mechanism 104, the sensor 105, and the wireless communication I/F 106 are communicably connected by, for example, a bus 109.

The processor 101 functions as an information processing device that controls the autonomous work machine 10, and is implemented by, for example, a central processing unit (CPU). The processor 101 is not limited to the CPU, and may be implemented by another digital circuit such as a field programmable gate array (FPGA) or a digital signal processor (DSP), or may be implemented by combining a plurality of digital circuits.

The memory 102 includes, for example, a main memory and an auxiliary memory. The main memory is used as a work area of the processor 101 and is implemented by, for example, a random access memory (RAM). The auxiliary memory is a computer-readable and non-transitory storage medium, and is implemented by, for example, a non-volatile memory such as a flash memory, a magnetic disk, or an optical disk. The auxiliary memory may include, for example, a portable memory removable from the autonomous work machine 10, such as various memory cards, an external solid state drive (SSD), or an external hard disk drive (HDD).

The auxiliary memory stores various programs and data related to the control of the autonomous work machine 10. The programs stored in the auxiliary memory are loaded on the main memory and executed by the processor 101. For example, a control unit in the present embodiment can be implemented by the processor 101 executing a program stored in the memory 102. In addition, the auxiliary memory may store three-dimensional point cloud information acquired using the sensor 105 to be described later.

The GNSS receiver 103 includes the GNSS antenna 13 (for example, the right antenna 13R and the left antenna 13L) and a GNSS module (not shown). The GNSS module specifies one point on a map as the current position of the autonomous work machine 10 based on the GNSS signal received by the GNSS antenna 13. Then, the GNSS antenna 13 outputs information indicating the position (for example, latitude and longitude) specified as the current position of the autonomous work machine 10 to the processor 101. The information indicating the position specified by the GNSS receiver 103 may be transmitted to an external device, such as a server, via the wireless communication I/F 106 to be described later.

The movement mechanism 104 is a mechanism that implements movement (for example, traveling or direction change) of the autonomous work machine 10. The movement mechanism 104 includes, for example, the wheels 12 described above, a motor (not shown) that drives the wheels 12, and a battery (not shown) that supplies electric power to the motor. In the movement mechanism 104, the motor drives the wheels 12 by electric power from the battery, thereby implementing the traveling and the direction change of the autonomous work machine 10.

The sensor 105 includes, for example, a vehicle sensor that acquires information on the autonomous work machine 10 and an external sensor that acquires information on the periphery of the autonomous work machine 10, and outputs the information acquired by the sensors to the processor 101. The information acquired by the sensors included in the sensor 105 may be transmitted to an external device, such as a server, via the wireless communication I/F 106 to be described later.

The vehicle sensor may include, for example, an acceleration sensor that detects an acceleration generated in the vehicle body 11, a wheel speed sensor that detects a rotation speed of the wheel 12, and the like. The acceleration sensor may include, for example, an inertial measurement unit (IMU) and a gyro sensor.

Examples of the external sensor include a camera, a light detection and ranging (LiDAR), a radar, and a sonar. Here, the camera is implemented by, for example, a digital camera using an imaging element such as a charge coupled device (CCD) or a complementary metal oxide semiconductor (CMOS), and outputs image data obtained by imaging the periphery of the autonomous work machine 10 to the processor 101.

The LiDAR emits laser light to the periphery of the autonomous work machine 10 and receives reflected light from an object present in the periphery of the autonomous work machine 10 to detect a distance, an orientation, and the like from the autonomous work machine 10 to the object, and outputs information indicating the detection result to the processor 101.

The radar emits radio waves to the periphery of the autonomous work machine 10 and receives reflected waves from an object present in the periphery of the autonomous work machine 10 to detect a distance, an orientation, and the like to the object, and outputs information indicating the detection result to the processor 101. As the radar, for example, a millimeter wave radar can be adopted.

The sonar emits sound waves to the periphery of the autonomous work machine 10, receives reflected sounds from an object present in the periphery of the autonomous work machine 10 to detect a distance, an orientation, and the like from the autonomous work machine 10 to the object, and outputs information indicating the detection result to the processor 101.

The processor 101 can acquire the three-dimensional point cloud information on the periphery of the autonomous work machine 10 based on, for example, information obtained by an external sensor such as a camera or LiDAR included in the sensor 105. Here, the three-dimensional point cloud information is information constituted by a set of three-dimensional coordinates (that is, “points”) of detection points of objects (hereinafter, also referred to as “object detection points”) present in the periphery of the autonomous work machine 10. For example, the processor 101 can acquire information indicating a vehicle speed that is a movement speed of the autonomous work machine 10 (in other words, the vehicle body 11), the acceleration generated in the autonomous work machine 10, and the like based on the information acquired by the vehicle sensor such as the wheel speed sensor included in the sensor 105. The processor 101 may transmit the acquired three-dimensional point cloud information and the information indicating the vehicle speed, the acceleration, and the like of the autonomous work machine 10 to an external device, such as a server, via the wireless communication I/F 106 to be described later.

The wireless communication I/F 106 is, for example, a communication interface that performs wireless communication with an external device (for example, a server) under the control of the processor 101. For such wireless communication, in addition to a moving object communication network such as so-called “4G” or “5G”, Wi-Fi (registered trademark), Bluetooth (registered trademark), Bluetooth Low Energy (BLE (registered trademark), low power wide area (LPWA), or the like can be adopted.

### Positioning of Autonomous Work Machine

Next, positioning of the autonomous work machine 10 will be described. Regarding positioning of the autonomous work machine 10, the autonomous work machine 10 (for example, the processor 101) can execute positioning by GNSS, positioning by self-position estimation using the three-dimensional point cloud information, and positioning by autonomous navigation (hereinafter, also referred to as “dead reckoning”). The processor 101 can adopt any one of the positions obtained by the positioning executable by the autonomous work machine 10 as the current position of the autonomous work machine 10.

Although a detailed description of the positioning described above is omitted since the positioning is well-known, in the positioning by the GNSS, one point on a map is specified as the position of the autonomous work machine 10 based on the GNSS signal received by the GNSS antenna 13 from the positioning satellite. The positioning by the GNSS is an example of first positioning for positioning the position of the autonomous work machine 10 (that is, the moving object) based on the signal from the positioning satellite.

In the self-position estimation using the three-dimensional point cloud information, for example, one point on the map is specified as the position of the autonomous work machine 10 based on a relative position between the autonomous work machine 10 and objects present in the periphery of the autonomous work machine 10 indicated by the three-dimensional point cloud information acquired via the sensor 105. The self-position estimation using the three-dimensional point cloud information is an example of the positioning using the three-dimensional point cloud information, and is an example of second positioning for positioning the position of the autonomous work machine 10 (that is, the moving object) by a method different from the first positioning. The self-position estimation using the three-dimensional point cloud information and generation of a map using the three-dimensional point cloud information (for example, a three-dimensional point cloud map to be described later) are also referred to as “simultaneous localization and mapping (SLAM)”.

In the dead reckoning, one point on the map is specified as the position of the autonomous work machine 10 by estimating an amount and a direction of the movement of the autonomous work machine 10 with respect to a past position of the autonomous work machine 10 from information such as the vehicle speed and the acceleration of the autonomous work machine 10 based on the detection result of the sensor 105 (for example, a vehicle sensor). The dead reckoning is an example of positioning using the detection result of the sensor 105 provided in the autonomous work machine 10 (that is, the moving object), and is another example of the second positioning for positioning the position of the autonomous work machine 10 by a method different from the first positioning.

### Reception State Estimation Method

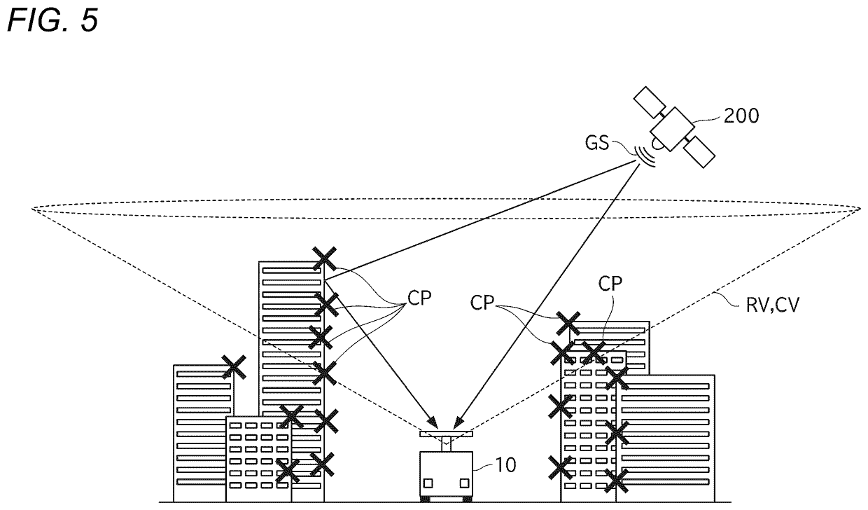

Next, a reception state estimation method of the GNSS signal in the present embodiment will be described with reference to FIGS. 5 to 7. In FIGS. 5 to 7, object detection points acquired via the sensor 105 (for example, an external sensor) are indicated by “× marks”.

As shown in FIG. 5, the autonomous work machine 10 autonomously moves while receiving a GNSS signal GS from a positioning satellite 200 by the GNSS antenna 13 and acquiring the three-dimensional point cloud information (that is, coordinates of the object detection points) using the sensor 105. Although only the positioning satellite 200 is shown as a positioning satellite in FIG. 5, it should be noted that the autonomous work machine 10 can receive GNSS signals from a plurality of positioning satellites including the positioning satellite 200.

For example, when the autonomous work machine 10 is activated (for example, autonomously moves), the processor 101 extracts, as target points CP, the object detection points included in the virtual inverted cone CV, which is the solid representing the receivable range RV of the GNSS antenna 13, from the three-dimensional point cloud information acquired using the sensor 105 at a predetermined cycle. As the extraction method, for example, a predetermined algorithm may be used to determine whether the object detection points included in the three-dimensional point cloud information are included in the virtual inverted cone CV, and the object detection point determined to be included in the virtual inverted cone CV may be extracted as the target point CP.

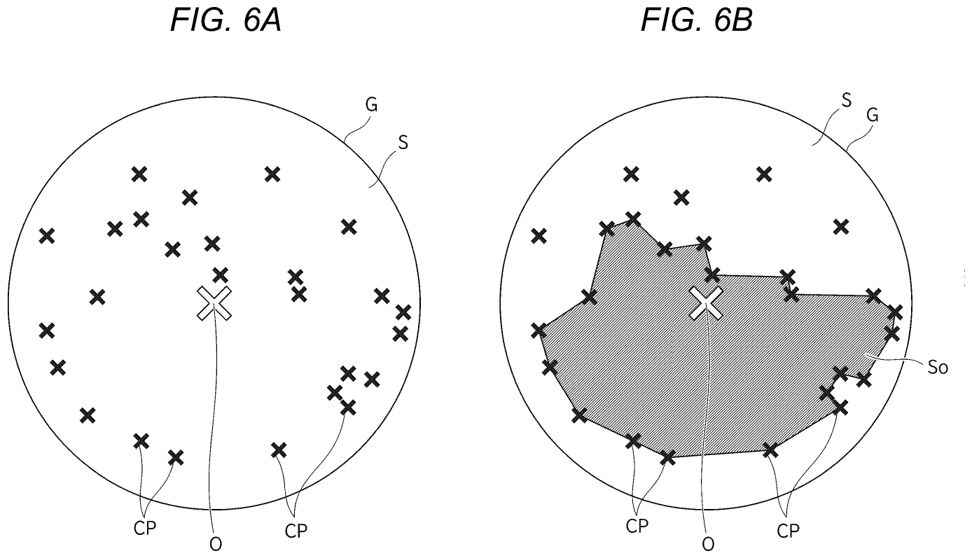

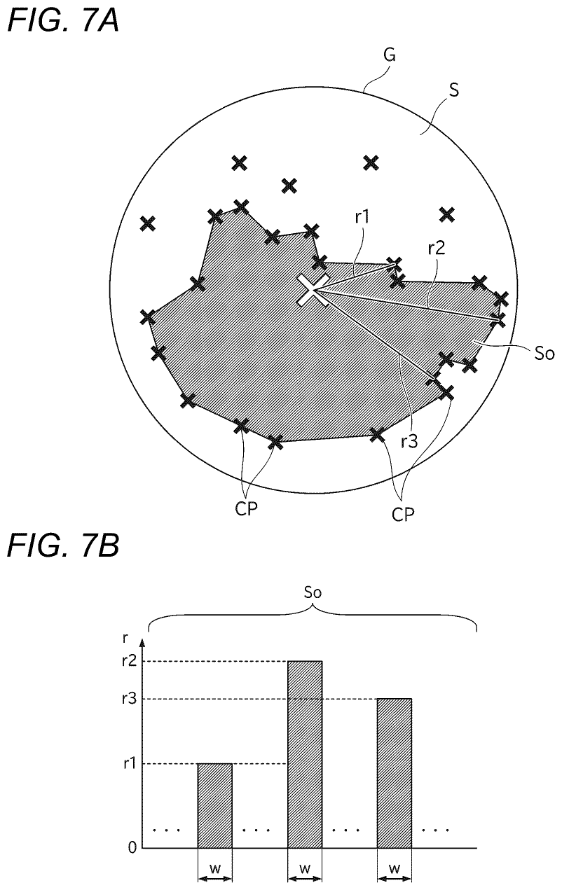

Then, as shown in FIG. 6A, the processor 101 generates a two-dimensional image G obtained by projecting the virtual inverted cone CV and the extracted target points CP (that is, the target points CP included in the virtual inverted cone CV) onto a two-dimensional plane from a direction corresponding to the vertical direction (that is, the upper-lower direction) of the autonomous work machine 10. The two-dimensional image G is loaded into a main memory, for example. It should be noted that, in FIG. 6A and FIGS. 6B and 7A to be described later, only some of the target points CP are denoted by reference numerals in order to make the drawings easy to see. That is, the object detection points indicated by “× marks” in FIGS. 6A, 6B, and 7A are the “target points CP”.

Next, as shown in FIG. 6B, the processor 101 derives a sky openness area So of the sky above the autonomous work machine 10 based on the target points CP in the two-dimensional image G. More specifically, when deriving the sky openness area So, the processor 101 first performs polar coordinate transformation on each of the target points CP in the two-dimensional image G with the coordinate corresponding to the autonomous work machine 10 (for example, a coordinate corresponding to a temporary self-position to be described later) as a center O.

Next, the processor 101 specifies a nearest target point CP to the center O (in other words, the target point CP having a shortest distance to the center O) at each of predetermined angles. Here, the predetermined angle may be freely determined by a manufacturer of the autonomous work machine 10, for example. As the predetermined angle is reduced, the sky openness area So can be derived with high accuracy. Then, the processor 101 derives the sky openness area So based on the specified nearest target points CP.

As an example, as shown in FIG. 7A, the processor 101 derives the sky openness area So based on a distance between each of the nearest target points CP and the center O (for example, r1, r2, r3 shown in FIG. 7A). More specifically, in this case, as shown in FIG. 7B, the processor 101 derives, for each of the nearest target points CP, an area of a rectangle having a length (in other words, a height) corresponding to the distance (r1, r2, r3, or the like) between the nearest target point CP and the center O and a constant width W (for example, 1), and integrates the areas of the rectangles corresponding to the respective nearest target points CP to derive the sky openness area So.

However, the method of deriving the sky openness area So is not limited to the above example. For example, the processor 101 may derive, by known geometric calculation, an area of a region inside a boundary line (that is, a region including the center O) formed by connecting the nearest target points CP angularly adjacent to each other from the center O with a line segment, and set the area as the sky openness area So.

Then, the processor 101 estimates the reception state of the GNSS signal GS in the autonomous work machine 10 (hereinafter, also simply referred to as the “reception state”) based on the derived sky openness area So. As an example, the processor 101 derives a sky openness ratio OR that is a ratio of the sky openness area So to the projected area S of the virtual inverted cone CV in the two-dimensional image G (that is, So/S), and estimates the reception state based on the sky openness ratio OR.

For example, when the sky openness ratio OR is large, it is considered that the number of objects present in the receivable range RV of the GNSS antenna 13 is small or a size thereof is small. Therefore, there is a high probability that the reception state is good. Therefore, the processor 101 may estimate that the reception state is good when the sky openness ratio OR is larger than a predetermined value. On the other hand, when the sky openness ratio OR is smaller than the predetermined value, the processor 101 may estimate that the reception state is poor.

As will be described later, the processor 101 may estimate the reception state by using another parameter (for example, DOP to be described later) different from the sky openness area So or the sky openness ratio OR. Further, the processor 101 may estimate the reception state simply based on the sky openness area So. As an example, the processor 101 may estimate that the reception state is good when the sky openness area So is larger than the predetermined value, and estimate that the reception state is poor when the sky openness area So is smaller than the predetermined value.

When any of the target points CP in the two-dimensional image G is overlapping the center O (that is, the coordinate corresponding to the autonomous work machine 10), there is a high probability that an object blocking the GNSS signal GS is present directly above the autonomous work machine 10 and the reception state is poor. Therefore, when any of the target points CP in the two-dimensional image G is overlapping the center O, the processor 101 may estimate that the reception state is poor. As an example, when any of the target points CP in the two-dimensional image G is overlapping the center O, the processor 101 may treat the sky openness area So or the sky openness ratio OR as 0 (zero). In this way, when an object blocking the GNSS signal GS may be present directly above the autonomous work machine 10, it is possible to estimate that the reception state is poor while reducing the calculation load for estimating the reception state.

### [Processing Procedure of Processor]

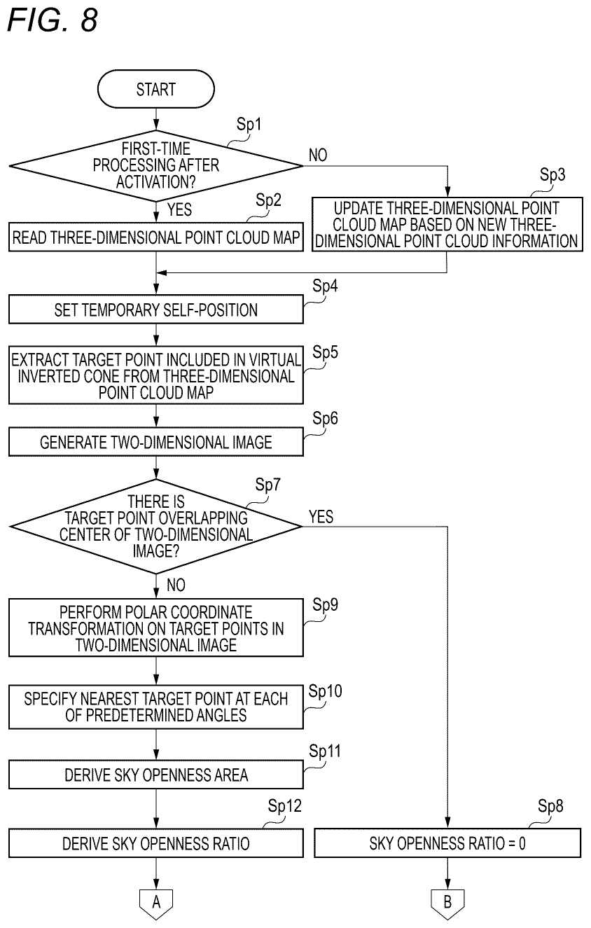

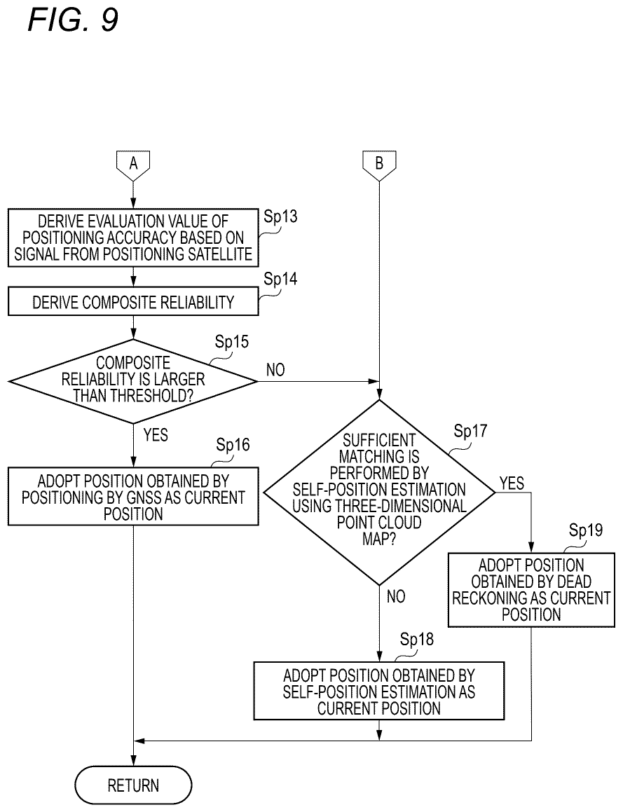

Next, an example of a processing procedure of the processor 101 will be described with reference to FIGS. 8 and 9. For example, when the autonomous work machine 10 is activated, the processor 101 executes a series of processing shown in FIGS. 8 and 9 at a predetermined cycle.

As shown in FIG. 8, the processor 101 first determines whether current processing is first-time processing after activation of the autonomous work machine 10 (step Sp1). If the processor 101 determines that the processing is the first-time processing after activation (step Sp1: YES), the processor 101 reads the three-dimensional point cloud map (step Sp2) and proceeds to processing of step Sp4.

In the processing of step Sp2, the processor 101 loads, for example, the three-dimensional point cloud map obtained by mapping the three-dimensional point cloud information stored in an auxiliary memory into a main memory. When the three-dimensional point cloud information is not stored in the auxiliary memory, in the processing of step Sp2, the processor 101 may acquire the current three-dimensional point cloud information on the periphery of the autonomous work machine 10 via the sensor 105 to load the three-dimensional point cloud map obtained by mapping the three-dimensional point cloud information into the main memory.

On the other hand, if it is determined that the processing is not the first-time processing after activation (step Sp1: NO), the processor 101 updates the three-dimensional point cloud map based on new three-dimensional point cloud information acquired in a period from the previous processing to the current processing (step Sp3), and proceeds to the processing of step Sp4.

Next, the processor 101 sets a temporary self-position (step Sp4). In the processing of step Sp4, the processor 101 may set, for example, a current estimated position of the autonomous work machine 10 obtained by odometry or the like based on the detection result of the sensor 105, as the temporary self-position.

Next, the processor 101 extracts, from the three-dimensional point cloud map (that is, the three-dimensional point cloud information), the target point CP included in the virtual inverted cone CV when the set temporary self-position is the vertex PC (step Sp5). Then, the processor 101 generates the two-dimensional image G obtained by projecting the virtual inverted cone CV and the target points CP onto a two-dimensional plane (step Sp6).

Next, the processor 101 determines whether there is a target point CP overlapping the center O (that is, the coordinate corresponding to the temporary self-position) of the two-dimensional image G, that is, whether an object blocking the GNSS signal GS from the positioning satellite 200 can be present directly above the autonomous work machine 10 (step Sp7).

If the processor 101 determines that there is the target point CP overlapping the center O of the two-dimensional image G (step Sp7: YES), the processor 101 sets the sky openness ratio OR to 0 (zero) (step Sp8) and proceeds to the processing of step Sp17 in FIG. 9.

On the other hand, if the processor 101 determines that there is no target point CP overlapping the center O of the two-dimensional image G (step Sp7: NO), the processor 101 performs polar coordinate transformation on each of the target points CP in the two-dimensional image G (step Sp9), and specifies the nearest target point CP at each of the predetermined angles (step Sp10).

Then, the processor 101 derives the sky openness area So based on the distance between each of the nearest target points CP and the center O (step Sp11), derives the sky openness ratio OR from the sky openness area So and the projected area S of the virtual inverted cone CV (step Sp12), and proceeds to the processing of step Sp13 in FIG. 9.

Next, as shown in FIG. 9, the processor 101 derives an evaluation value X of the positioning accuracy based on the signal from the positioning satellite 200 (step Sp13). The evaluation value X is derived based on, for example, dilution of precision (DOP) representing deterioration of the positioning accuracy in a satellite positioning system such as GNSS. As this DOP, for example, horizontal dilution of precision (HDOP) can be adopted. Although a detailed description of a method for deriving the DOP such as HDOP is omitted since the method is well-known, the DOP takes a value of 0 (zero) or more, and the larger the value, the larger the deterioration (that is, the lower the positioning accuracy).

More specifically, in the processing of step Sp13, the processor 101 derives, for example, a value obtained by scaling from a minimum value “0 (zero)” to a maximum value “1” using, for example, DOP (for example, HDOP), as the evaluation value X. As an example, the processor 101 derives a value obtained by dividing “1” by “1+DOP” as the evaluation value X (that is, X=1/(1+DOP)). The evaluation value X derived in this way is, for example, “0.33 . . . ” when DOP=2, and is “0.2” when DOP=4, that is, the evaluation value X decreases as DOP increases.

Next, the processor 101 derives a composite reliability CC representing the reception state based on the derived sky openness ratio OR and the evaluation value X (step Sp14). In the processing of step Sp14, the processor 101 derives, for example, a product of the sky openness ratio OR and the evaluation value X as a composite reliability CC. In this case, the composite reliability CC increases in proportion to each of the sky openness ratio OR and the evaluation value X, and the larger the composite reliability CC, the better the reception state.

Next, the processor 101 determines whether the derived composite reliability CC is larger than a predetermined threshold, that is, whether the reception state is good (step Sp15). The threshold used in the processing of step Sp15 is set in advance by, for example, the manufacturer of the autonomous work machine 10.

Then, if the processor 101 determines that the composite reliability CC is larger than the threshold, that is, the reception state is good (step Sp15: YES), the processor 101 adopts the position obtained by the positioning by GNSS as the current position of the autonomous work machine 10 (step Sp16), and ends the current processing.

On the other hand, if the processor 101 determines that the composite reliability CC is equal to or smaller than the threshold, that is, the reception state is poor (step Sp15: NO), the processor 101 determines whether sufficient matching can be performed by the self-position estimation using the three-dimensional point cloud map (step Sp17).

Then, if the processor 101 determines that the sufficient matching can be performed by the self-position estimation (step Sp17: YES), the processor 101 adopts the position obtained by the self-position estimation as the current position of the autonomous work machine 10 (step Sp18), and ends the current processing.

On the other hand, if the processor 101 determines that the sufficient matching cannot be performed by the self-position estimation (step Sp17: NO), the processor 101 adopts the position obtained by the dead reckoning as the current position of the autonomous work machine 10 (step Sp19), and ends the current processing.

### Effects of Present Embodiment

According to the present embodiment, the processor 101 acquires the three-dimensional point cloud information on the periphery of the autonomous work machine 10, and extracts the target points CP included in the virtual inverted cone CV, which is a solid representing the receivable range RV of the GNSS antenna 13, from the acquired three-dimensional point cloud information. Then, the processor 101 generates the two-dimensional image G obtained by projecting the virtual inverted cone CV and the extracted target points CP onto the two-dimensional plane, and estimates the reception state of the GNSS signal GS from the positioning satellite 200 in the autonomous work machine 10 based on the target points CP in the two-dimensional image G. Accordingly, the processor 101 can extract the target points CP, which are part of the three-dimensional point cloud information, and perform two-dimensionalization on the target points CP to estimate the reception state in the autonomous work machine 10. Therefore, compared with a case where the reception state is estimated using the three-dimensional point cloud information as it is, it is possible to accurately estimate the reception state while reducing the calculation load for estimating the reception state.

In the present embodiment, the solid representing the receivable range RV of the GNSS antenna 13 is a virtual inverted cone CV which is a cone whose bottom surface faces directly above the autonomous work machine 10. Accordingly, since the reception state can be estimated using the virtual inverted cone CV which is a solid simulating the hardware-based receivable range of the GNSS antenna 13, as compared with a case where the reception state is estimated using a solid having another shape, it is possible to more accurately estimate the reception state.

For example, the processor 101 derives the sky openness area So of the sky above the autonomous work machine 10 based on the target points CP in the two-dimensional image G, and estimates the reception state based on the sky openness area So. Accordingly, since the reception state can be estimated based on the sky openness area So, the reception state can be accurately estimated from the two-dimensional image G.

For example, the processor 101 performs the polar coordinate transformation on each of the target points CP in the two-dimensional image G with the coordinate corresponding to the autonomous work machine 10 as the center O, specifies the nearest target point CP to the center O at each of the predetermined angles, and derives the sky openness area So based on the distance between each of the nearest target points CP and the center O. As an example, the processor 101 derives, for each of the nearest target points CP, an area of a rectangle having a length corresponding to the distance between the nearest target point CP and the center O and a constant width W, and integrates the areas of the rectangles corresponding to the respective nearest target points CP to derive the sky openness area So. Accordingly, the sky openness area So can be derived from the discrete target points CP by a simple calculation.

For example, the processor 101 derives the sky openness ratio OR that is a ratio between the sky openness area So and the projected area S of the virtual inverted cone CV in the two-dimensional image G, and estimates the reception state based on the sky openness ratio OR. Accordingly, the reception state can be estimated based on the sky openness ratio OR that is the ratio between the sky openness area So and the projected area S of the virtual inverted cone CV (that is, the receivable range RV of the GNSS antenna 13) in the two-dimensional image G. Therefore, the reception state can be estimated in consideration of the ratio of the sky openness area So to the receivable range RV, and the reception state can be accurately estimated.

For example, the processor 101 estimates the reception state based on the sky openness ratio OR and the evaluation value X representing the positioning accuracy based on the signal (for example, the GNSS signal GS) from the positioning satellite. Accordingly, since the reception state can be estimated using not only the sky openness ratio OR but also the evaluation value representing the positioning accuracy based on the signal from the positioning satellite, it is possible to more accurately estimate the reception state as compared with a case where the reception state is estimated using only the sky openness ratio OR.

For example, the evaluation value X takes a larger value as the positioning accuracy is higher, and the processor 101 estimates that the reception state is good when the composite reliability CC, which is the product of the sky openness ratio OR and the evaluation value X, is larger than the threshold, and estimates that the reception state is poor when the composite reliability CC is equal to or smaller than the threshold. Accordingly, the processor 101 can appropriately estimate the reception state from the composite reliability CC (that is, the product of the sky openness ratio OR and the evaluation value X) obtained by a simple calculation.

In the example described above, the composite reliability CC is obtained regardless of the sky openness ratio OR, but the present invention is not limited thereto. For example, when the sky openness ratio OR is equal to or smaller than the predetermined value, there is a high probability that the reception state is poor. Therefore, when the sky openness ratio OR is equal to or smaller than the predetermined value, the processor 101 may estimate that the reception state is poor regardless of the evaluation value X. As described above, when the sky openness ratio OR is equal to or smaller than the predetermined value, the reception state is estimated to be poor regardless of the evaluation value X, so that the reception state can be estimated to be poor without obtaining the composite reliability CC. Therefore, it is possible to reduce an amount of calculation while preventing a decrease in the estimation accuracy of the reception state in this case.

For example, when any of the target points CP in the two-dimensional image G is present on the coordinate corresponding to the autonomous work machine 10 (for example, the center O), the processor 101 estimates that the reception state is poor. That is, when any of the target points CP in the two-dimensional image G is overlapping the coordinate corresponding to the autonomous work machine 10, there is a high probability that an object blocking the signal from the positioning satellite is present directly above the autonomous work machine 10 and the reception state is poor. Therefore, when any of the target points in the two-dimensional image G is overlapping the coordinate corresponding to the autonomous work machine 10, the processor 101 estimates that the reception state is poor, so that it is possible to reduce the amount of calculation for estimating the reception state while preventing the decrease in the estimation accuracy of the reception state.

For example, regarding the positioning of the autonomous work machine 10, the autonomous work machine 10 is configured to execute “positioning by GNSS” as the first positioning for specifying the position of the autonomous work machine 10 based on the signal from the positioning satellite and the second positioning for specifying the position of the autonomous work machine 10 by a method different from the positioning by GNSS. When the processor 101 estimates that the reception state is good, the processor 101 adopts the position obtained by the positioning by GNSS as the current position of the autonomous work machine 10. On the other hand, when the processor 101 estimates that the reception state is poor, the processor 101 adopts the position obtained by the second positioning as the current position of the autonomous work machine 10. Accordingly, it is possible to adopt, as the current position of the autonomous work machine 10, an appropriate position in consideration of the reception state between the position obtained by the positioning by the GNSS and the position obtained by the second positioning. In particular, in the case of a moving object that autonomously moves such as the autonomous work machine 10, the autonomous work machine 10 can appropriately perform the autonomous movement by allowing the autonomous work machine 10 to grasp an appropriate current position.

The above second positioning can be, for example, positioning using the three-dimensional point cloud information or positioning by autonomous navigation using the detection result of the sensor 105 provided in the autonomous work machine 10. Accordingly, when the reception state is estimated to be poor, that is, when the reliability of the position obtained by the positioning by the GNSS (that is, the first positioning) is estimated to be low, the position obtained by the positioning using the three-dimensional point cloud information or obtained by the positioning by the autonomous navigation using the detection result of the sensor 105 provided in the autonomous work machine 10 can be adopted as the current position of the autonomous work machine 10.

Like the right antenna 13R and the left antenna 13L, a plurality of receivers that receive signals from positioning satellites may be provided in the autonomous work machine 10. In this case, for example, as in the virtual inverted cone CV described above, the solid used for estimating the reception state can be a single solid that includes the receivable ranges of each of the plurality of receivers. In this way, for example, even if the plurality of receivers are provided in the autonomous work machine 10 for a reason of obtaining information on a posture of the autonomous work machine 10, it is possible to accurately estimate the reception state while reducing the calculation load for estimating the reception state.

More specifically, for example, the processor 101 extracts, as the target point CP, an object detection point included in the virtual inverted cone CV, in other words, an object detection point included in one inverted cone. Therefore, as compared with a case where the object detection point included in the receivable range RR of the right antenna 13R and the object detection point included in the receivable range RL of the left antenna 13L are separately extracted, it is possible to decrease the amount of calculation when extracting the target point CP. Therefore, as compared with the case where the object detection point included in the receivable range RR of the right antenna 13R and the object detection point included in the receivable range RL of the left antenna 13L are separately extracted, it is possible to accurately estimate the reception state with a small amount of calculation.

When only a single antenna is provided in the autonomous work machine 10 as the GNSS antenna 13, the processor 101 may estimate the reception state by using a solid such as a cone, a truncated cone, or a hemisphere representing a receivable range of the antenna instead of the virtual inverted cone CV. For example, it is assumed that only the right antenna 13R of the right antenna 13R and the left antenna 13L is provided in the autonomous work machine 10. In this case, the processor 101 may estimate the reception state by using the inverted cone CR representing the receivable range RR of the right antenna 13R instead of the virtual inverted cone CV.

An information processing method described in the embodiments described above can be implemented by executing a program prepared in advance by a processor (in other words, a computer). The program is stored in a computer-readable storage medium and executed by being read from the storage medium. In addition, the program may be provided in a form stored in a non-transitory storage medium such as a flash memory, or may be provided via a network such as the Internet. The processor that executes the program may be, for example, a processor included in the autonomous work machine 10 (for example, the processor 101), but is not limited thereto, and may be included in an external device (for example, a server) capable of communicating with the autonomous work machine 10.

### Modification of Information Processing System 1 of Present Embodiment

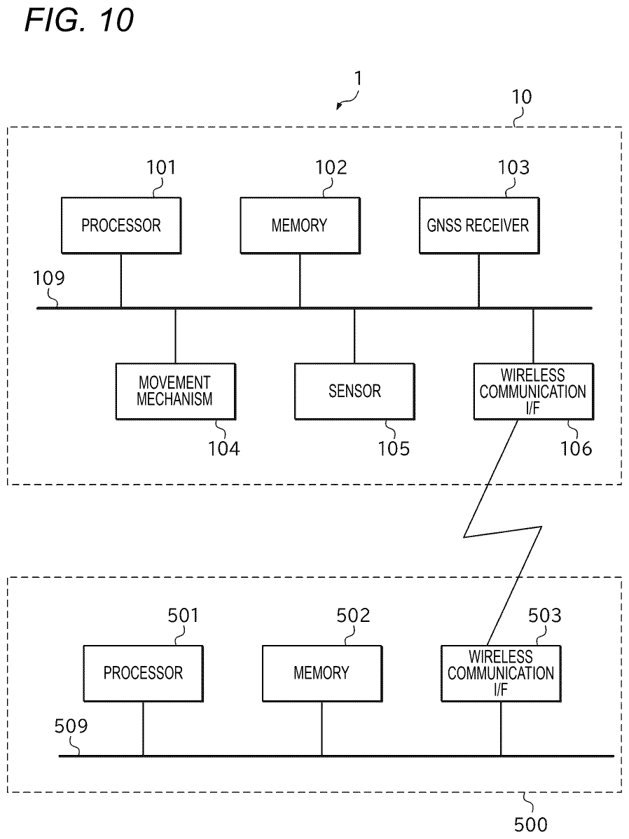

FIG. 10 is a diagram showing a modification of the information processing system 1 of the present embodiment. The information processing system 1 shown in FIG. 10 includes the autonomous work machine 10 and a server 500 capable of communicating with the autonomous work machine 10. Each of the constituent elements of the autonomous work machine 10 in the information processing system 1 shown in FIG. 10 is the same as the corresponding constituent element of the autonomous work machine 10 shown in FIG. 4.

The server 500 in the information processing system 1 shown in FIG. 10 includes a processor 501, a memory 502, and a communication I/F 503. The processor 501, the memory 502, and the communication I/F 503 are communicably connected by, for example, a bus 509.

Similarly to the processor 101, the processor 501 is implemented by, for example, a CPU or the like, and functions as an information processing device that controls the server 500. Similarly to the memory 102, the memory 502 includes, for example, a main memory and an auxiliary memory, and stores various programs and data related to control of the server 500. Similarly to the wireless communication I/F 106, the communication I/F 503 communicates with an external device (for example, the autonomous work machine 10) under the control of the processor 501.

In the information processing system 1 shown in FIG. 10, for example, the processor 101 of the autonomous work machine 10 may transmit various types of information necessary for estimating the reception state, such as the three-dimensional point cloud information acquired via the sensor 105, to the server 500 via the wireless communication I/F 106. Then, the processor 501 of the server 500 may estimate the reception state by performing the same processing as the processor 101 described above based on the information received from the autonomous work machine 10. In this case, the same effects as those of the embodiments described above can also be obtained. Further, in this case, the server 500 may transmit, to the autonomous work machine 10, information indicating the current position of the autonomous work machine 10 adopted based on an estimation result of the reception state (for example, the composite reliability CC). In this way, the autonomous work machine 10 can grasp an appropriate current position of the autonomous work machine 10, and can appropriately perform the autonomous movement.

For example, the processing may be shared and executed by the processor 101 of the autonomous work machine 10 and the processor 501 of the server 500 such that a part of the processing shown in FIGS. 8 and 9 is executed by the processor 101 of the autonomous work machine 10 and the remaining processing is executed by the processor 501 of the server 500.

Although various embodiments of the present invention have been described above with reference to the drawings, it is needless to say that the present invention is not limited to these examples. It is apparent to those skilled in the art that various changes or modifications can be conceived within the scope described in the claims, and it is understood that the changes or modifications naturally fall within the technical scope of the present invention. In addition, constituent elements in the embodiment described above may be freely combined without departing from the gist of the present invention.

For example, in the embodiments described above, the moving object is the autonomous work machine 10, but the present invention is not limited thereto. The present invention is also applicable to, for example, other types of moving objects such as a passenger car, an aircraft, a lawn mower, or a drone, which is provided with a receiver that receives a signal from a positioning satellite.

In the present specification, at least the following matters are described. Although corresponding constituent elements or the like in the above embodiment are shown in parentheses, the present invention is not limited thereto.

(1) An information processing method for estimating a reception state of a signal (GNSS signal GS) from a positioning satellite (positioning satellite 200) in a moving object (autonomous work machine 10) provided with a receiver (GNSS antenna 13, right antenna 13R, left antenna 13L) that receives the signal, including: acquiring, by a processor (processor 101, 501), three-dimensional point cloud information on a periphery of the moving object; extracting, by the processor, a target point (target points CP) included in a predetermined solid (virtual inverted cone CV) from the three-dimensional point cloud information, the predetermined solid representing a receivable range of the receiver (Step Sp5); generating, by the processor, a two-dimensional image (two-dimensional image G) obtained by projecting the target point included in the solid onto a two-dimensional plane from a direction corresponding to a vertical direction of the moving object (Step Sp6); and estimating, by the processor, the reception state based on the target point in the two-dimensional image (Steps Sp7 to 14).

According to (1), a part of the three-dimensional point cloud information is extracted and subjected to two-dimensionalization, and the reception state of the signal from the positioning satellite in the moving object is estimated. Accordingly, as compared with a case where the reception state is estimated using the three-dimensional point cloud information as it is, it is possible

to accurately estimate the reception state while reducing the calculation load for estimating the reception state.

(2) The information processing method according to (1), in which
the solid is a cone (virtual inverted cone CV), a truncated cone, or a hemisphere whose bottom surface faces directly above the moving object.

In general, the hardware-based receivable range of the receiver typically forms a cone, a truncated cone, or a hemisphere whose bottom surface faces directly above the moving object. According to (2), since the reception state can be estimated using the solid simulating the hardware-based receivable range of the receiver, as compared with a case where the reception state is estimated using a solid having another shape, it is possible to more accurately estimate the reception state.

(3) The information processing method according to (1) or (2), further including
deriving, by the processor, a sky openness area (sky openness area So) of sky above the moving object based on the target point in the two-dimensional image (Step Sp11), and
estimating, by the processor, the reception state based on the sky openness area.

According to (3), since the reception state can be estimated based on the sky openness area of the sky above the moving object in the two-dimensional image, it is possible to accurately estimate the reception state from the two-dimensional image.

(4) The information processing method according to (3), further including
performing, by the processor, polar coordinate transformation on each of the target points in the two-dimensional image with a polar coordinate corresponding to the moving object as a center (Step Sp9),
specifying, by the processor, a nearest target point to the center at each of predetermined angles (Step Sp10), and
deriving, by the processor, the sky openness area based on a distance between each of the nearest target points and the center.

According to (4), it is possible to derive the sky openness area from discrete target points by a simple calculation.

(5)) The information processing method according to (4), further including
deriving, by the processor, for each of the nearest target points, an area of a rectangle having a constant width and a length corresponding to the distance between the nearest target point and the center, and
deriving, by the processor, the sky openness area by integrating the areas of the rectangles corresponding to the respective nearest target points.

According to (5)), it is possible to derive the sky openness area from the discrete target points by a simple calculation.

(6) The information processing method according to (3), further including
deriving, by the processor, a sky openness ratio which is a ratio between the sky openness area and a projected area of the solid in the two-dimensional image (Step Sp12), and
estimating, by the processor, the reception state based on the sky openness ratio.

According to (6), the reception state is estimated based on the sky openness ratio which is the ratio between the sky openness area and the projected area of the solid (that is, the receivable range of the receiver) in the two-dimensional image. Accordingly, since the reception state can be estimated in consideration of the ratio of the sky openness area to the receivable range of the receiver, it is possible to accurately estimate the reception state.

(7) The information processing method according to (6), further including
estimating, by the processor, the reception state based on the sky openness ratio and a predetermined evaluation value (evaluation value X) representing a positioning accuracy based on the signal (Steps Sp14 and 15).

According to (7), since the reception state can be estimated using not only the sky openness ratio but also the evaluation value representing the positioning accuracy based on the signal from the positioning satellite, as compared with a case where the reception state is estimated using only the sky openness ratio, it is possible to more accurately estimate the reception state.

(8) The information processing method according to (7), in which the evaluation value takes a larger value as the positioning accuracy is higher, the information processing method further including
estimating, by the processor, that the reception state is good when a product of the sky openness ratio and the evaluation value is larger than a threshold, and
estimating, by the processor, that the reception state is poor when the product is equal to or smaller than the threshold.

According to (8), it is possible to appropriately estimate the reception state from the product of the sky openness ratio and the evaluation value obtained by a simple calculation.

(9) The information processing method according to (8), further including
estimating, by the processor, that the reception state is poor regardless of the evaluation value when the sky openness ratio is equal to or smaller than a predetermined value.

When the sky openness ratio is equal to or smaller than the predetermined value, there is a high probability that the reception state is poor. According to (9), when the sky openness ratio is equal to or smaller than the predetermined value, the reception state is estimated to be poor regardless of the evaluation value, so that the reception state can be estimated to be poor without obtaining the product of the sky openness ratio and the evaluation value. Therefore, it is possible to reduce an amount of calculation while preventing a decrease in the estimation accuracy of the reception state in this case.

(10) The information processing method according to (1) or (2), further including
estimating, by the processor, that the reception state is poor when any of the target points in the two-dimensional image is overlapping a coordinate corresponding to the moving object.

When any of the target points in the two-dimensional image is overlapping the coordinate corresponding to the moving object, there is a high probability that an object blocking the signal from the positioning satellite is present directly above the moving object and the reception state is poor. According to (10), when any of the target points in the two-dimensional image is overlapping the coordinate corresponding to the moving object, the reception state is estimated to be poor, so that it is possible to reduce the amount of calculation for estimating the reception state while preventing the decrease in the estimation accuracy of the reception state.

(11) The information processing method according to (1), in which
regarding positioning of the moving object, the moving object is configured to execute first positioning for specifying a position of the moving object based on the signal and second positioning for specifying the position of the moving object by a method different from the first positioning, further including
adopting, by the processor, the position obtained by the first positioning as a current position of the moving object when the reception state is estimated to be good, and
adopting, by the processor, the position obtained by the second positioning as the current position of the moving object when the reception state is estimated to be poor.

According to (11), it is possible to adopt, as the current position of the moving object, an appropriate position in consideration of the reception state between the position obtained by the first positioning and the position obtained by the second positioning. In particular, when the moving object is a moving object that autonomously moves, the moving object can appropriately perform the autonomous movement by allowing the moving object to grasp an appropriate current position.

(12) The information processing method according to (11), in which
the second positioning is positioning using the three-dimensional point cloud information or positioning by autonomous navigation using a detection result of a sensor provided in the moving object.

According to (12), when the reception state is estimated to be poor, that is, when the reliability of the position obtained by the first positioning is estimated to be low, the position obtained by the positioning using the three-dimensional point cloud information or obtained by the positioning by the autonomous navigation using the detection result of the sensor provided in the moving object can be adopted as the current position of the moving object.

(13) The information processing method according to (1) or (2), in which
when a plurality of the receivers is provided in the moving object, the solid is a single solid that includes receivable ranges of each of the plurality of receivers.

According to (13), for example, even if the plurality of receivers are provided in the moving object for a reason of obtaining information on a posture of the moving object or the like, since the reception state can be estimated using a single solid including the receivable range of each of the plurality of receivers, it is possible to accurately estimate the reception state while reducing the calculation load for estimating the reception state.

(14) An information processing device that estimates a reception state of a signal (GNSS signal GS) from a positioning satellite (positioning satellite 200) in a moving object (autonomous work machine 10) provided with a receiver (GNSS antenna 13, right antenna 13R, left antenna 13L) that receives the signal, the information processing device (autonomous work machine 10, processor 101, server 500, processor 501) including:
a processor (processor 101, processor 501) configured to
   acquire three-dimensional point cloud information on a periphery of the moving object,
   extract a target point (target points CP) included in a predetermined solid (virtual inverted cone CV) from the three-dimensional point cloud information, the predetermined solid representing a receivable range of the receiver,
   generate a two-dimensional image (two-dimensional image G) obtained by projecting the target point included in the solid onto a two-dimensional plane from a direction corresponding to a vertical direction of the moving object, and
   estimate the reception state based on the target point in the two-dimensional image.

According to (14), a part of the three-dimensional point cloud information is extracted and subjected to two-dimensionalization, and the reception state of the signal from the positioning satellite in the moving object is estimated. Accordingly, as compared with a case where the reception state is estimated using the three-dimensional point cloud information as it is, it is possible to accurately estimate the reception state while reducing the calculation load for estimating the reception state.

(15) An information processing system (information processing system 1) including an information processing device (autonomous work machine 10, processor 101, server 500, processor 501) according to (14) and a moving object (autonomous work machine 10) provided with a receiver (GNSS antenna 13, right antenna 13R, left antenna 13L) that receives a signal l (GNSS signal GS) from a positioning satellite (positioning satellite 200).

According to (15), a part of the three-dimensional point cloud information is extracted and subjected to two-dimensionalization, and the reception state of the signal from the positioning satellite in the moving object is estimated. Accordingly, as compared with a case where the reception state is estimated using the three-dimensional point cloud information as it is, it is possible to accurately estimate the reception state while reducing the calculation load for estimating the reception state.

(16) A non-transitory computer-readable storage medium storing a program for causing a computer to execute a process for estimating a reception state of a signal from a positioning satellite in a moving object provided with a receiver that receives the signal, the process including:
acquiring three-dimensional point cloud information on a periphery of the moving object;
extracting a target point included in a predetermined solid from the three-dimensional point cloud information, the predetermined solid representing a receivable range of the receiver;
generating a two-dimensional image obtained by projecting the target point included in the solid onto a two-dimensional plane from a direction corresponding to a vertical direction of the moving object; and estimating the reception state based on the target point in the two-dimensional image.

According to (16), a part of the three-dimensional point cloud information is extracted and subjected to two-dimensionalization, and the reception state of the signal from the positioning satellite in the moving object is estimated. Accordingly, as compared with a case where the reception state is estimated using the three-dimensional point cloud information as it is, it is possible to accurately estimate the reception state while reducing the calculation load for estimating the reception state.

What is claimed is:

1. An information processing method for estimating a reception state of a signal from a positioning satellite in a moving object provided with a receiver that receives the signal, comprising:
acquiring, by a processor, three-dimensional point cloud information on a periphery of the moving object;
extracting, by the processor, a target point included in a predetermined solid from the three-dimensional point cloud information, the predetermined solid representing a receivable range of the receiver;
generating, by the processor, a two-dimensional image obtained by projecting the target point included in the solid onto a two-dimensional plane from a direction corresponding to a vertical direction of the moving object; and
estimating, by the processor, the reception state based on the target point in the two-dimensional image.

2. The information processing method according to claim 1, wherein
the solid is a cone, a truncated cone, or a hemisphere whose bottom surface faces directly above the moving object.

3. The information processing method according to claim 1, further comprising
deriving, by the processor, a sky openness area of sky above the moving object based on the target point in the two-dimensional image, and
estimating, by the processor, the reception state based on the sky openness area.

4. The information processing method according to claim 3, further comprising
performing, by the processor, polar coordinate transformation on each of the target points in the two-dimensional image with a polar coordinate corresponding to the moving object as a center,
specifying, by the processor, a nearest target point to the center at each of predetermined angles, and
deriving, by the processor, the sky openness area based on a distance between each of the nearest target points and the center.

5. The information processing method according to claim 4, further comprising
deriving, by the processor, for each of the nearest target points, an area of a rectangle having a constant width and a length corresponding to the distance between the nearest target point and the center, and
deriving, by the processor, the sky openness area by integrating the areas of the rectangles corresponding to the respective nearest target points.

6. The information processing method according to claim 3, further comprising
deriving, by the processor, a sky openness ratio which is a ratio between the sky openness area and a projected area of the solid in the two-dimensional image, and
estimating, by the processor, the reception state based on the sky openness ratio.

7. The information processing method according to claim 6, further comprising
estimating, by the processor, the reception state based on the sky openness ratio and a predetermined evaluation value representing a positioning accuracy based on the signal.

8. The information processing method according to claim 7, wherein
the evaluation value takes a larger value as the positioning accuracy is higher,
the information processing method further comprising estimating, by the processor, that the reception state is good when a product of the sky openness ratio and the evaluation value is larger than a threshold, and
estimating, by the processor, that the reception state is poor when the product is equal to or smaller than the threshold.

9. The information processing method according to claim 8, further comprising
estimating, by the processor, that the reception state is poor regardless of the evaluation value when the sky openness ratio is equal to or smaller than a predetermined value.

10. The information processing method according to claim 1, further comprising
estimating, by the processor, that the reception state is poor when any of the target points in the two-dimensional image is overlapping a coordinate corresponding to the moving object.

11. The information processing method according to claim 1, wherein
regarding positioning of the moving object, the moving object is configured to execute first positioning for specifying a position of the moving object based on the signal and second positioning for specifying the position of the moving object by a method different from the first positioning, further comprising
adopting, by the processor, the position obtained by the first positioning as a current position of the moving object when the reception state is estimated to be good, and
adopting, by the processor, the position obtained by the second positioning as the current position of the moving object when the reception state is estimated to be poor.

12. The information processing method according to claim 11, wherein
the second positioning is positioning using the three-dimensional point cloud information or positioning by autonomous navigation using a detection result of a sensor provided in the moving object.

13. The information processing method according to claim 1, wherein
when a plurality of the receivers is provided in the moving object, the solid is a single solid that includes receivable ranges of each of the plurality of receivers.

14. An information processing device that estimates a reception state of a signal from a positioning satellite in a moving object provided with a receiver that receives the signal, the information processing device comprising:
a processor configured to
acquire three-dimensional point cloud information on a periphery of the moving object,
extract a target point included in a predetermined solid from the three-dimensional point cloud information, the predetermined solid representing a receivable range of the receiver,
generate a two-dimensional image obtained by projecting the target point included in the solid onto a two-dimensional plane from a direction corresponding to a vertical direction of the moving object, and
estimate the reception state based on the target point in the two-dimensional image.

15. An information processing system comprising the information processing device according to claim 14 and a moving object provided with a receiver that receives a signal from a positioning satellite.

16. A non-transitory computer-readable storage medium storing a program for causing a computer to execute a process for estimating a reception state of a signal from a positioning satellite in a moving object provided with a receiver that receives the signal, the process comprising:
acquiring three-dimensional point cloud information on a periphery of the moving object;
extracting a target point included in a predetermined solid from the three-dimensional point cloud information, the predetermined solid representing a receivable range of the receiver;
generating a two-dimensional image obtained by projecting the target point included in the solid onto a two-dimensional plane from a direction corresponding to a vertical direction of the moving object; and estimating the reception state based on the target point in the two-dimensional image.
